(19) United States
(12) Patent Application Publication
(10) Pub. No.: US 2015/0095228 A1
(43) Pub. Date: Apr. 2, 2015

(54) CAPTURING IMAGES FOR FINANCIAL TRANSACTIONS

(71) Applicants: Libo Su, San Jose, CA (US); Egan Schulz, San Jose, CA (US); Michelle Serrano, San Jose, CA (US)

(72) Inventors: Libo Su, San Jose, CA (US); Egan Schulz, San Jose, CA (US); Michelle Serrano, San Jose, CA (US)

(21) Appl. No.: 14/137,793

(22) Filed: Dec. 20, 2013

Related U.S. Application Data
(60) Provisional application No. 61/885,378, filed on Oct. 1, 2013.

(51) Int. Cl. G06Q 20/08

(52) U.S. Cl. CPC G06Q 20/08
USPC 705/44

(57) ABSTRACT

Systems and methods for facilitating financial transactions by using images from a real-world environment are described. By obtaining the image and information associated with the image, a user may supplement the user's view of the real-world in real-time. For example, the images can be used to determine the status of shoppers, to buy products from television or the Internet, make payments to others, shop at a physical store, or check-in a user. A user's view of the real-world can be supplemented with information associated with the image.

### CROSS-REFERENCE TO RELATED APPLICATION

Pursuant to 35 U.S.C. §119(e), this application claims priority to the filing date of U.S. Provisional Patent Application No. 61/885,378, filed Oct. 1, 2013, which is incorporated by reference in its entirety.

### BACKGROUND

1. Field of the Invention

The present invention relates to the use of augmented reality devices and systems, and in particular, to their use to facilitate financial transactions.

2. Related Art

Computing devices such as personal computers, laptop computers, tablet computers, cellular phones, smartphone, and countless types of Internet-capable devices are increasingly prevalent in numerous aspects of modern life. The number of users, devices, and device capabilities continue to increase. Device capabilities include accessing content, such as through the Internet or Apps, taking and sharing photos, videos, and music, playing games, listening to music, watching videos, shopping, and performing financial transactions, such as sending and receiving money. Thus, a need exists for methods that provide information to a user in a more intelligent, more efficient, more intuitive, and/or less obtrusive manner.

### BRIEF DESCRIPTION OF THE FIGURES

FIG. 1 is a block diagram illustrating a system for facilitating financial transactions according to an embodiment of the present disclosure;

FIG. 2 is a flowchart showing a method for facilitating financial transactions according to an embodiment of the present disclosure; and

FIG. 3 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes techniques for facilitating electronic commerce in an augmented reality environment. Augmented reality provides a user with a live view of a physical, real-world environment, augmented with artificial computer-generated sound, video and/or graphic information. A device typically displays the live view of the physical, real-world environment on a screen or the like, and the artificial, computer-generated information is overlaid on the user's live view of the physical, real-world environment.

Augmented reality can be incorporated and used on smartphones and other user devices. Mobile devices, especially wearable ones that may be in the form of eyewear (e.g., Google Glass®), mobile-enabled wrist watches, or head-mounted displays, are available to provide augmented reality experiences to users. Such devices typically include display technology by which computer information is overlaid on the scene in front of the user.

In an augmented reality environment, relevant information regarding a physical object or person can be rendered or presented with the object or person so as to augment the object or person. Such information or data can be about the person or object that are in or near a particular geographical location. Further the device can facilitate transactions associated with the object or person when the user is physically near the object or person.

The present disclosure describes the use of images from a real-world environment obtained in real-time to facilitate financial transactions related to the image. By obtaining a real-time image and information associated with the image, a user may selectively supplement the user's view of the real-world in real-time. The present methods and systems offer the user functionality that may make the user's view of the real-world more useful to the needs of the user. In particular, the user's view of the real-world can be supplemented with information associated with the image. For example, the captured images of shoppers can be used to determine the status of shoppers, the captured image of a product can be used to buy products from television, the Internet, or a physical store, the captured image of a person can be used to make payments to that person, or the captured image of a location can be used to check-in a user.

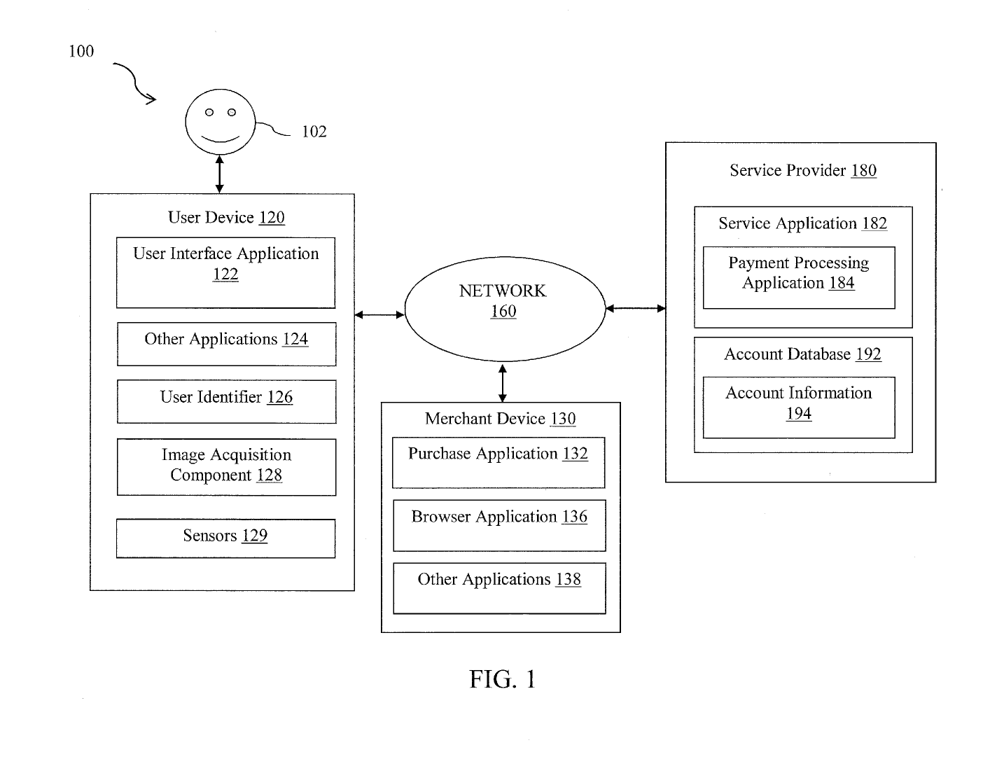

FIG. 1 shows one embodiment of a block diagram of a network-based system 100 adapted to facilitate financial transactions with a user device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 (e.g., a smartphone), one or more merchant devices 130 (e.g., network server devices), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the user device 120, merchant device 130, and service provider server or device 180 may be associated with a particular link (e.g., a link, such as a URL (Uniform Resource Locator) to an IP (Internet Protocol) address).

The user device 120, in various embodiments, may be implemented using any appropriate combination of hardware and/or software configured for wired and/or wireless communication over the network 160. The user device 120, in one embodiment, may be utilized by the user 102 to interact with the service provider server 180 over the network 160. For example, the user 102 may conduct financial transactions (e.g., account transfers, bill payment, purchases, deposits, withdrawals, loans, etc.) with the service provider server 180 via the user device 120. In various implementations, the user device 120 may include a wireless telephone (e.g., cellular or mobile phone), a tablet, a personal digital assistant (PDA), a personal computer, a notebook computer, a smartphone, cover headsets, heads-up displays, helmet mounted display, head-mounted display, scanned-beam display, and/or other suitable mobile computing devices that are configured to facilitate or enable an augmented reality environment or platform.

In one embodiment, the user device 120 includes a wearable computing device, such as Google Glass®, smart watches, or smart glasses/goggles. A wearable computing device may be configured to allow visual perception of a real-world environment and to display computer-generated information related to the visual perception of the real-world environment. Advantageously, the computer-generated information may be integrated with a user's perception of the real-world environment. For example, the computer-generated information may supplement a user's perception of the physical world with useful computer-generated information or views related to what the user is perceiving or experiencing at a given moment.

The user device 120, in one embodiment, includes a user interface application 122, which may be utilized by the user 102 to conduct transactions (e.g., shopping, purchasing, bidding, etc.) with the service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

The user device 120, in various embodiments, may include other applications 124 as may be desired in one or more embodiments of the present disclosure to provide additional features available to user 102. In one example, such other applications 124 may include security applications for implementing client-side security features, calendar application, contacts application, location-based services application, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The user device 120, in one embodiment, may include at least one user identifier 126, which may be implemented, for example, as operating system registry entries, cookies associated with the user interface application 122, identifiers associated with hardware of the user device 120, or various other appropriate identifiers. The user identifier 126 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The user device 120, in one embodiment, includes a geo-location component adapted to monitor and provide an instant geographical location (i.e., geo-location) of the user device 120. In one implementation, the geo-location of the user device 120 may include global positioning system (GPS) coordinates, zip-code information, area-code information, street address information, and/or various other generally known types of geo-location information. In one example, the geo-location information may be directly entered into the user device 120 by the user 102 via a user input component, such as a keyboard, touch display, and/or voice recognition microphone. In another example, the geo-location information may be automatically obtained and/or provided by the user device 120 via an internal or external GPS monitoring component. In other embodiments, the geo-location can be automatically obtained without the use of GPS. In some instances, cell signals or wireless signals are used. This helps to save battery life and to allow for better indoor location where GPS typically does not work.

In some embodiments, the user device 120 includes an image acquisition component 128, for example, a camera (e.g., a digital camera or video camera). The image acquisition component 128 may be any device component capable of capturing images of objects and/or people from a real-time environment.

In various embodiments, the user device 120 also includes various sensors 129. For example, the sensors 129 may include a location sensor, a motion/gesture sensor, and/or an environmental stimulus sensor. The location sensor can include GPS receivers, radio frequency (RF) transceivers, an optical rangefinder, etc. The motion/gesture sensor is operable to detect motion of the user device 120. Motion detecting can include detecting velocity and/or acceleration of the user device 120 or a gesture of the user 102 handling the user device 120. The motion/gesture sensor can include for example, an accelerometer. The environmental stimulus sensor can detect environmental factors or changes in environmental factors surrounding the real environment in which the user device 120 is located. Environmental factors can include, weather, temperature, topographical characters, density, surrounding businesses, buildings, living objects, etc. These factors or changes in them can affect the positioning of the presented information for the objects and/or people in the augmented reality in which they are presented to the user 102 via the user device 120.

Merchant device 130, which can be similar to user device 120, may be maintained by one or more service providers (e.g., merchant sites, auction site, marketplaces, social networking sites, etc.) offering various items, such as products and/or services, through stores created through the service provider or their websites. Merchant device 130 may be in communication with a merchant server capable of handling various on-line transactions. The merchant (which could be any representative or employee of the merchant) can process online transactions from consumers making purchases through the merchant site from user devices. Merchant device 130 may include purchase application 132 for offering products/services for purchase.

Merchant device 130, in one embodiment, may include a browser application 136 and other applications 138. Browser application 136 and other applications 138 enable the merchant to access a payment provider web site and communicate with service provider server 180, such as to convey and receive information to allow the merchant to provide location and item information to the service provider. Other applications 138 may also include location-determination capabilities and interfaces to allow unmanned transactions with a user.

The service provider server 180, in one embodiment, may be maintained by a transaction processing entity, which may provide processing for financial transactions and/or information transactions between the user 102 and the merchant device 130. As such, the service provider server 180 includes a service application 182, which may be adapted to interact with the user device 120 and/or the merchant device 130 over the network 160 to facilitate payment by the user 102 to, for example, the merchant device 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and the merchant device 130. In one implementation, the payment processing application 184 assists with resolving financial transactions through validation, delivery, and settlement. As such, the service application 182 in conjunction with the payment processing application 184 settles indebtedness between the user 102 and the merchant 130, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant device 130). For example, account information 194 may include private financial information of user 102 and each merchant associated with the one or more merchant devices 130, such as one or more account numbers, passwords, credit card information, banking information, or other types of financial information, which may be used to facilitate financial transactions between user 102, and, for example, the one or more merchants associated with the merchant device 130. In various aspects, the methods and systems described herein may be modified to accommodate users and/or merchants that may or may not be associated with at least one existing user account and/or merchant account, respectively.

In various embodiments, the payment processing application 184 recognizes, analyzes and processes an image to obtain relevant information from the image. The processing application 184 may also receive input commands from the user device 120 regarding what information to display to the user 102.

In one implementation, the user 102 may have identity attributes stored with the service provider server 180, and user 102 may have credentials to authenticate or verify identity with the service provider server 180. User attributes may include personal information, banking information and/or funding sources as previously described. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

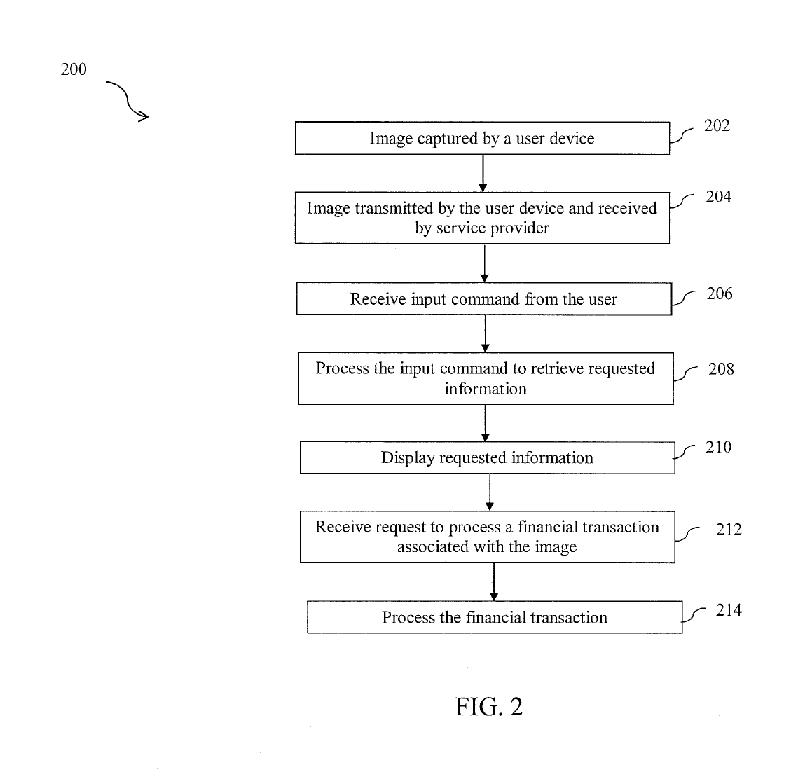

Referring now to FIG. 2, a flowchart of a method 200 for facilitating financial transactions is illustrated according to an embodiment of the present disclosure. In an embodiment, at step 202, the user device 120 scans, obtains or captures an image from a real-world environment or in real-time. The image may be anything or anyone viewed by the user 102 and may include a plurality of items or people. Any user device suitable for capturing an image, such as a smart watch, or a mobile device with a camera may be used. The image may be of a person, object, animal, plant, etc. In various embodiments, the image is obtained using a wearable computing device, such as Google Glass®. In this embodiment, the user device 120 can detect the presence of an object when the object is seen, viewed, or looked at by the user 102.

The user 102 may indicate to the wearable computing device which portion of the user's real-world view the user 102 would like to take an image of. In some embodiments, the user 102 can indicate the desired portion by using a pointer and/or making a gesture. For example, the user 102 can move a pointer or select an area on the display of the user device 120 to point at or frame the object in a reticle or a circular or rectangular frame. In various embodiments, the user device 120 can provide the user 102 with a lasso or a selection tool in the perspective to surround a respective target so as to form the select area. Additionally, the user device 120 can prompt the user 102 to choose the object(s) of interest from a set of choices such as a number of targets that are recognized in the perspective.

In detecting the user's gesture to move a pointer or targeting or selection tool, and/or to select an object, the user device 120 can capture the gesture from one or more of: (i) movements or non-movements of an eye of the user 102, (ii) locations of a focal point of an eye of the user 102, or (iii) movements of an eye lid of the user 102. Additionally, the user device 120 can capture the gesture from one or more of: (i) movements of a hand or finger as recognized by a camera of the user device 120, (ii) movements of a virtual pointer controlled by a wireless peripheral device, (iii) movements of a virtual pointer controlled by a touch-sensitive display of the user device 120, (iv) movements of the user device 120 itself, or (v) movements of the user's head, limbs, or torso. The capturing can be further based on a speed or velocity of the movements.

As such, the present embodiments can capture or identify gestures from, for example, winking of the user 102 and/or an eye focus or eye foci of the user 102. Another example of gesture controlling can include finger or arm gesturing as captured by camera and/or distance detector/proximity detectors, so that the user 102 can perform “spatial” or “virtual” gesturing in the air or other detectable spaces with similar gestures as those well-known gestures applicable to a mobile phone's touch screen. Yet another example of gesture controlling can include eye ball motion tracking and/or eye focal point tracking. In this way, the user of user device 120 may operate various selection mechanisms, for example, by using his or her eyes (e.g., via eye movement tracking) or by moving his or her hands/arms/fingers in the perspective to make specific gestures such as pointing or tracing the outline of some object, or by operating a virtual pointer in the scene using a handheld peripheral such as a wireless pointing device or a mouse equivalent, or by touching a touch-sensitive display on the user device 120 and gesturing on it to indicate actions and selections, or by moving the device itself with specific gestures and velocities to use the device as a pointer or selection tool. Additional gestures may include eye tracking and determining a focus of the eye for targeting things, and/or blinking to select a target that is in the focal point, to take a photo, or to select a button, etc.

After receiving the user's selection or choice of the object of interest, the user device 120 can optionally confirm with the user 102 the choice of the object of interest. The confirmation can include highlighting or outlining the target in the augmented reality display.

The image may be a part or all of what the user sees. For example, the user 102 may be viewing a shelf full of products. The user can then zoom in or otherwise indicate/identify which one or more of the products the user 102 wishes to take an image of. In some embodiments, the user 102 may be viewing the real-time image. The desired image is then captured by the user device 120, such as through a camera on the user device 120.

At step 204, the image is transmitted by the user device 120 and received by the service provider server 180. In one embodiment, the image may be in an image format such as a Joint Picture Experts Group (JPEG) format, a bitmap (BMP) format, a graphic interchange format (GIF), or a Portable Network Graphic (PNG) format.

In some embodiments, the presence of an object is detected or identified in the augmented reality environment by one or more of: (i) a visual marker; (ii) a marker or tag; (iii) a one-dimensional barcode; or (iv) a multi-dimensional barcode, on the object. For example, a marker on the object such as a Quick Response (QR) code or other augmented reality marker can be presented for identification or detection. In another example, a barcode representing a stock-keeping unit number (SKU) may be present. The barcode can be one-dimensional or multi-dimensional.

In various embodiments, the service provider performs facial recognition to identify the faces detected on the display of the user device 120. Facial recognition is typically performed in real-time, to provide identification suggestions for any detected faces that may, for example, correspond to friends in the user's social network. For instance, the service provider can examine the user's contact list, communications (e.g., people with whom the user emails often), second and higher degree contacts (e.g., friends of friends), social networking groups and affiliations (e.g., followed fan pages, alumni group memberships), or other groups of users defined by particular social groups, to identify other users with whom the user has social relationships.

At step 206, the service provider receives an input command from the user 102 via the user device 120. The commands can be received in a variety of ways, such as through a touch-pad, a gesture, a voice command, or a remote device. In some embodiments, the user 102 may provide commands to the user device 120 that indicate what the user 102 wants to do with the image. For example, the user 102 may want pricing and availability information of a product in the image, amount owed to a person in the image, or how much is owed by a person in the image.

At step 208, the service provider processes the input command to retrieve the requested information. In one embodiment, the service provider performs a search for the requested information using text, images, or other suitable information.

At step 210, the requested information, i.e., information associated with the command and the image, is displayed on the user device 120. In various embodiments, when the requested information relates to financial information or financial transactions, the service provider server 180 is able to retrieve the information from the relevant merchant and/or service provider database. Financial information encompasses a wide variety of information, including, but not limited to, purchases, payments, loans, bank accounts, credit card accounts, transfers, sales, discounts, promotions, coupons, advertisements, etc.

For example, the user 102 can request how much a product in an image costs, and the cost of the product is displayed on the user device 120. Product information, such as a description and/or image, may also be displayed so that the user 102 can confirm the price displayed corresponds to the intended item. Other information that can be displayed include reviews, availability, and/or price comparisons.

In another embodiment, a merchant requests information associated with a customer, such as payment status, items in a digital cart, past purchases, and/or amount spent. Payment status can be determined, for example, by checking the customer's digital cart to see if the items in the cart were purchased and payment processed. The merchant can also access the customer's digital cart to determine what the customer is planning to purchase, and offer coupons or discounts based on the items in the digital cart. Information associated with past purchases and amount spent, such as items bought (including color, size, and style), cost of items, and date purchased, can be provided to the merchant. Based on past purchases and the items in the digital cart, a merchant can understand the kinds of items the customer is interested in and recommend additional items or suggest something new. Based on the amount spent, the merchant can determine whether or not the customer is a loyal customer, and can give exclusive discounts or sales items to that customer.

In one embodiment, the merchant can scan inventory on shelves to determine if any products need to be reordered. The merchant can also request information regarding any advertisements or promotions related to the scanned items. For example, the user device 120 may display emails that have been sent to customers and sales outcomes, and the merchant can determine how many more discounts are needed to get the products off the shelves. If the merchant sees that inventory is low and that there is an upcoming promotion for the product, the merchant can decide to order more of the product.

In yet another embodiment, the user 102 requests that payment be made to a friend or that a payment be requested from a friend. The user 102 can confirm the amount requested or the amount of payment, and the identity of the friend on the user device 120. In some embodiments, the friend's contact information may also be displayed.

In some embodiments, the information is rendered translucently and disposed adjacently or partially overlaid with the image depicted in the augmented reality environment on the user device 120. In one embodiment, the information is displayed on an optical see-through display, an optical see-around display, or a video see-through display of a wearable computing device. Such displays may allow the user 102 to perceive a view of a real-world environment and may also be capable of displaying computer-generated images that appear to interact with the real-world view perceived by the user 102. In particular, “see-through” wearable computing devices may display graphics on a transparent surface so that the user 102 sees the graphics overlaid on the physical world. On the other hand, “see-around” wearable computing devices may overlay graphics on the physical world by placing an opaque display close to the user's eye to take advantage of the sharing of vision between a user's eyes and create the effect of the display being part of the world seen by the user 102.

At step 212, the service provider receives a request to process a financial transaction associated with the image. For example, the user 102 may want to buy the product shown in the image and request that the service provider process the payment for the product. In another example, the user 102 may want to pay the person shown in the image and request the service provider to transfer funds to the person. The request may be communicated by user input into a keyboard or touch display and/or by voice command.

At step 214, the financial transaction is processed. The user 102 may receive a notification that the transaction has been completed. The notification may be transmitted by the service provider and received by the user 102 through a user device, which can be the same as user device 120 or another device associated with the user 102. Notification may be through voice, text, and/or other visual/audio indicators.

### Examples

Exemplary methods may involve a wearable computing device for obtaining images from a real-world environment and receiving desired information associated with the images. In some embodiments, a tablet version of the wearable computing device may be used. Particular examples will now be described.

Users shopping in a physical store and using a digital cart no longer require receipt checking at the door. The users may be automatically checked in upon walking into the store. Merchants can equip employees with wearable devices that are aware of who has an active shopping cart, has already paid, or has no activity. Through semi-transparent, virtually projected colors using a tool such as Google Glass® or a camera on a smart device (e.g., iPad, iPhone, etc.) superimposed over each shopper, the merchant can easily scan the store and see: (1) people who have already purchased their items (in one embodiment, a green overlay), (2) people with an active shopping cart, but have not paid yet (in one embodiment, a red overlay), and (3) people with no items or are shopping without a digital cart (in one embodiment, no overlay). Shopping becomes a more fluid reflex, reduces lines, and allows merchants to quickly scan shoppers from a comfortable distance to know their shopping status and, in some embodiments, prevent shoplifting.

Merchants can also offer certain customers using a digital cart specific shopping experiences. Once a customer is identified, merchants can provide, for example, coupons, exclusive offers, sale items, advertisements, etc. to loyal shoppers and/or power shoppers based on what they have in their digital cart. Merchants can also access the shoppers' previous purchases to determine what they like and, based on that information, offer those shoppers items that they are likely to be interested in. For example, if a shopper had previously purchased a pair of navy blue pants in a size 6, the merchant can recommend the matching navy blue jacket in a size 6. Loyal shoppers can be identified based on how frequently they visit the store, how often they make a purchase, how much they spend in the store, and/or if they have a store credit card. Power shoppers can be identified based on the time they spend in the store and/or how much they spend in the store.

Employees of merchants can also quickly scan inventory and determine what items are needed and need to be reordered. For example, an employee equipped with a wearable device such as Google Glass® is able to scan the barcodes on inventory to determine how much inventory of a specific item is being stored. In addition, while taking inventory, the employee can check if any scanned items are on sale or will be on sale, or if there are any planned promotions of the item. If an item is running low, the employee can suggest that more of that item be ordered. If an item has been on sale for a while and there are still high inventory levels of the item, the employee can suggest that the item be further discounted or that more promotions be run.

A user is able to order items while watching commercials or a TV show. A user watching TV notices an item, for example a t-shirt, that he or she likes. While watching the commercial or show, the user says “Order one in medium” to the user device. The user device responds with “Order t-shirt in medium and pay with PayPal?” The user nods or answers “Yes.” The user is asked to confirm shipping or pickup location.

A user is able to pay a friend back. A friend paid for a user's lunch yesterday, and the user wants to pay him back. The user looks at the friend and activates facial recognition on the user device. The user device recognizes the friend by detecting the friend's face and comparing the face with pictures of the user's contacts in his email list, social networks, etc. The user device then displays a series of actions the user can perform. The user says, “OK, send $10.50,” and is asked to confirm. The user device sends money immediately to the friend.

A user is able to split a bill easily. When out with friends, the user wants to split a restaurant bill 4 ways. The user scans the bill and says “OK, split the bill . . . ,” and then the user looks at each person at the table who will be splitting the bill. The user device confirms the identity of each person using facial recognition and splits the bill evenly amongst everyone scanned.

A user is able to share products and views with others. When out shopping in a store, a user scans the barcode of a table, the type of table is identified, and he is presented with prices, reviews, competitive pricing, etc. for the table. He may also send the scanned item, along with reviews and pricing, to a friend or family member to get their opinion. Before he decides to purchase the table, he wants to see how the table would look like at home. Because he previously scanned the house and placed a marker where the table will go, he can select an option and request to view the table in any room (e.g., dining room) to see how it looks. He decides that the table is perfect and adds it to his shopping cart. He continues shopping and finds a table cloth for the table. He scans the table cloth and obtains product information for the table cloth. He requests that the table cloth information be sent to his wife, and while he is still looking at the table cloth, his wife responds in a text that the table cloth looks great.

A user is able to shop smartly. A grocery shopping list can be scanned, and the user device can give the user the most direct path to each product. The shopping list can be displayed on the user device, and based on the identity of the items and the location of the user device, the user device can determine where in the grocery store the items are located. The user device can then map out the best route to take through the grocery store. In one example, the shopping list includes milk, eggs, bread, and cheese. The user device may design a route that takes the user to the dairy aisle first to get the eggs, milk, and cheese, and then to the bread/cereal aisle to get to the bread.

In some embodiments, the user can also view a real-time running budget on the user device as items are crossed off the shopping list. As the user places items in his or her cart, he or she can take the items off the shopping list, and the price of the items can be deducted from the grocery budget. The user may be alerted when the total is getting close to the budget cap. Coupons can also be added that aren't already in the user's wallet, based on products in the shopping cart. For example, if the user's shopping cart contains items that the store has on sale, but the user doesn't have the coupon for an item, the service provider can automatically charge the sale price (rather than the normal price).

A user is able to shop faster. For example, a user performs a search on the Internet and scans a product or captures an image of a product (e.g., song, movie, clothing, etc.) directly from the results page without going to a particular merchant website. This saves the user time because the user does not need to navigate through the merchant website to select the desired product. Once the product is identified, product information such as color, size, price, availability, reviews, description, and photos, may be displayed on the user device. The user can then add the product to the shopping cart and check out.

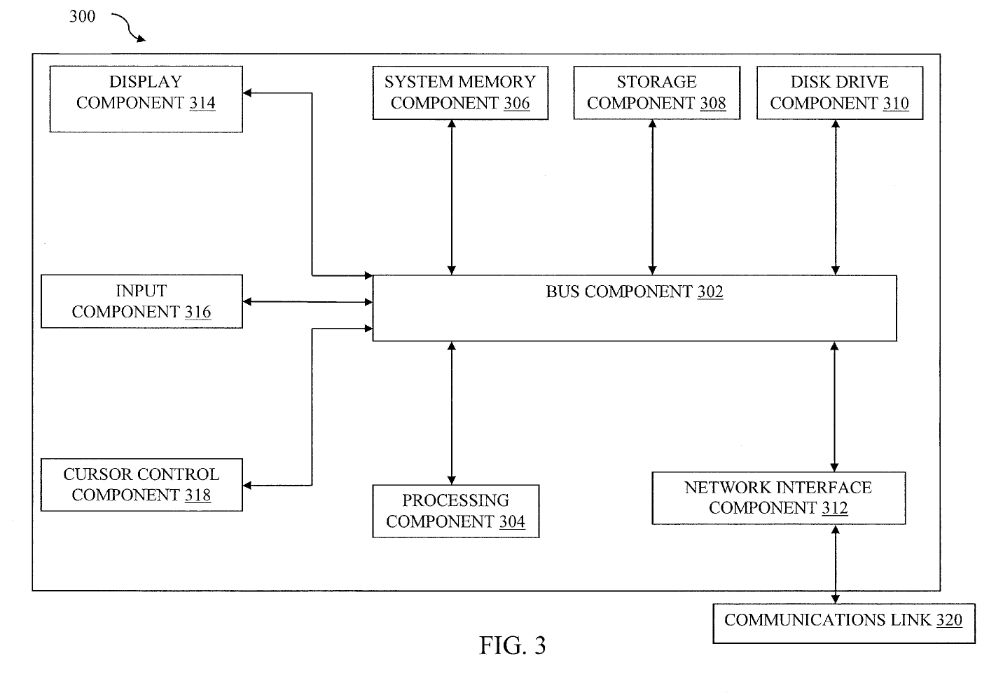

Referring now to FIG. 3, a block diagram of a system 300 is illustrated suitable for implementing embodiments of the present disclosure, including user device 120, one or more merchant servers or devices 130, and service provider server or device 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for facilitating financial transactions.

Although various components and steps have been described herein as being associated with user device 120, merchant device 130, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing user account information, wherein the user account information comprises financial account information; and
one or more processors in communication with the memory device and operable to:
receive an image from a real-world environment in real-time from a user device;
receive at least one input command that is associated with the image; and
display information associated with the command and image on the user device.

2. The system of claim 1, wherein the one or more processors is further operable to receive a request to process a financial transaction associated with the image.

3. The system of claim 2, wherein the one or more processors is further operable to process the financial transaction.

4. The system of claim 1, wherein the user device comprises a wearable computing device.

5. The system of claim 1, wherein the at least one input command is associated with an image of a person.

6. The system of claim 5, wherein the at least one input command comprises a command to determine a shopping status of the person, determine past purchases made by the person, determine items in a shopping cart of the person, determine amount owed by the person, determine amount owed to the person, make a payment to the person, or a combination thereof.

7. The system of claim 1, wherein the at least one input command is associated with an image of an item.

8. The system of claim 7, wherein the at least one input command comprises a command to determine promotions or advertisements associated with the item, determine how much of the item is in inventory, determine product information associated with the item, share the item with a contact, determine a budget associated with the item, determine a location of the item, or a combination thereof.

9. A method for facilitating a financial transaction, comprising:
receiving, by one or more hardware processors of a service provider, an image from a real-world environment in real-time from a user device;
receiving at least one input command that is associated with the image; and
displaying information associated with the command and image on the user device.

10. The method of claim 9, further comprising receiving a request to process a financial transaction associated with the image.

11. The method of claim 10, further comprising processing the financial transaction.

12. The method of claim 9, wherein the user device comprises a wearable computing device.

13. The method of claim 9, wherein the at least one input command is associated with an image of a person or an item.

14. The method of claim 13, wherein the at least one input command comprises a command to determine a shopping status of the person, determine past purchases made by the person, determine items in a shopping cart of the person, determine amount owed by the person, determine amount owed to the person, make a payment to the person, or a combination thereof.

15. The method of claim 13, wherein the at least one input command comprises a command to determine promotions or advertisements associated with the item, determine how much of the item is in inventory, determine product information associated with the item, share the item with a contact, determine a budget associated with the item, determine a location of the item, or a combination thereof.

16. A non-transitory machine-readable medium comprising a plurality of machine-readable instructions which, when executed by one or more processors, are adapted to cause the one or more processors to perform a method comprising:
receiving an image from a real-world environment in real-time from a user device;
receiving at least one input command that is associated with the image; and
displaying information associated with the command and image on the user device.

17. The non-transitory machine-readable medium of claim 16, wherein the method further comprises receiving a request to process a financial transaction associated with the image.

18. The non-transitory machine-readable medium of claim 17, wherein the method further comprises processing the financial transaction.

19. The non-transitory machine-readable medium of claim 16, wherein the at least one input command is associated with an image of a person or an item.

20. The non-transitory machine-readable medium of claim 19, wherein at least one input command comprises a command to determine a shopping status of the person, determine past purchases made by the person, determine items in a shopping cart of the person, determine amount owed by the person, determine amount owed to the person, make a payment to the person, determine promotions or advertisements associated with the item, determine how much of the item is in inventory, determine product information associated with the item, share the item with a contact, determine a budget associated with the item, determine a location of the item, or a combination thereof.
